(19) United States
(12) Patent Application Publication
(10) Pub. No.: US 2015/0005985 A1
(43) Pub. Date: Jan. 1, 2015

(54) MODULAR AUTOMOTIVE CAMERA AND IMAGE PROCESSING SYSTEM FOR AUTOMATED PORTAL ENTRY

(71) Applicant: FLEXTRONICS AUTOMOTIVE INC., Newmarket (CA)

(72) Inventor: Pompilian Tofilescu, Newmarket (CA)

(73) Assignee: FLEXTRONICS AUTOMOTIVE INC., Newmarket, ON (CA)

(21) Appl. No.: 14/363,961

(22) PCT Filed: Dec. 10, 2012
(86) PCT No.: PCT/CA2012/050886

§ 371 Date: Jun. 9, 2014

Related U.S. Application Data
(60) Provisional application No. 61/568,828, filed on Dec. 9, 2011.

(51) Int. Cl. E05F 15/20; G07C 5/08; G06K 9/78

(52) U.S. Cl. CPC E05F 15/2076; G06K 9/78; G07C 5/0866
USPC 701/2; 701/49

(57) ABSTRACT

Described herein is a system and method for vehicle portal activation without a user having to use a manually activated mechanism. In one embodiment, a modular automotive camera solution (MACS) module in conjunction with an image processing system is used for automated portal entry. The MACS module recognizes the presence of a user and controls the opening of, for example, a lift gate, when operating as a rear view camera and working in conjunction with a passive entry system and power lift gate module (PLGM). The MACS module has a camera module functioning as a continuous sensor. The camera module is a complementary metal-oxide-semiconductor (CMOS) sensor based camera configured to output analog National Television System Committee (NTSC) composite video and digital video. The image processing module performs image processing and communicates with the PLGM and the MACS module. The system is configured for local interconnect network (LIN) communication.

### CROSS REFERENCE TO RELATED APPLICATIONS

This application claims the benefit of U.S. Provisional Application No. 61/568,828, filed Dec. 9, 2012, the contents of which are hereby incorporated by reference herein.

### FIELD OF INVENTION

This application is related to vehicle electronics.

### BACKGROUND

Vehicles have a number of portals including automatic power lift gates, sliding doors, and doors. Drivers may need to get access to a vehicle's lift gate or trunk but may be unable to access their keys in order to unlock and open the portal due to, for example, carrying objects or the cold. It is one aspect of the invention to provide a system and method of activating a door, gate or other apparatus of a vehicle without the user having to retrieve a key or other manually activated device.

### SUMMARY

Described herein is a system and method of activating a vehicle portal without a user having to retrieve a key or use a manually activated mechanism. In one embodiment, a modular automotive camera solution (MACS) module is used in conjunction with an image processing system and for automated portal entry. The MACS module can be used to recognize the presence of a user and to control the opening of, for example, a lift gate when installed in the vehicle as a rear view camera and working in conjunction with a passive entry system and a powered lift gate module (PLGM). The MACS module has a camera module functioning as a continuous sensor as part of a lift gate motor control mechanism. The camera module is a complementary metal-oxide-semiconductor (CMOS) sensor based camera that can be configured to output both analog National Television System Committee (NTSC) composite video and digital video through a low voltage differential signaling (LVDS) output. An image processing module performs the image processing and communicates with both the PLGM and the MACS module. The system is configured for local interconnect network (LIN) communication.

### BRIEF DESCRIPTION OF THE DRAWINGS

FIG. 1 is an embodiment of an automated portal entry system;

FIG. 2 is an embodiment of a modular automotive camera solution (MACS module);

FIG. 3 is an embodiment of an image processing engine (IPE) module;

FIGS. 4A and 4B are embodiments of a power management circuit with connections to other circuits for the MACS and IPE modules;

FIG. 5 is an embodiment of an enable circuit and a local interconnect network circuit with connections to other circuits for the MACS and IPE modules;

FIGS. 6 is an embodiment of a microcontroller circuit with connections to other circuits for the MACS and IPE modules;

FIG. 7 is an embodiment of circuitry interconnecting the microcontroller circuit of FIG. 6 and an image sensor of FIG. 8;

FIG. 8 is an embodiment of an image sensor with connections to other circuits for the MACS and IPE modules; and

FIG. 9 is an embodiment of a serializer with connections to other circuits for the MACS and IPE modules;

FIG. 10 is an embodiment of an automated portal entry system with a MACS module integrated with an IPE module; and

FIG. 11 is an embodiment of an automated portal entry system with a power lift gate module (PLGM) integrated with an IPE module.

### DETAILED DESCRIPTION

It is to be understood that the figures and descriptions of embodiments of the system for automated vehicle portal entry have been simplified to illustrate elements that are relevant for a clear understanding, while eliminating, for the purpose of clarity, many other elements found in typical vehicle systems. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein.

The non-limiting embodiments described herein are with respect to an automated vehicle portal entry system. Other electronic devices, modules and applications may also be used in view of these teachings without deviating from the spirit or scope as described herein. The automated vehicle portal entry system may be modified for a variety of applications and uses while remaining within the spirit and scope of the claims. The embodiments and variations described herein, and/or shown in the drawings, are presented by way of example only and are not limiting as to the scope and spirit. The descriptions herein may be applicable to all embodiments of the automated vehicle portal entry system although it may be described with respect to a particular embodiment.

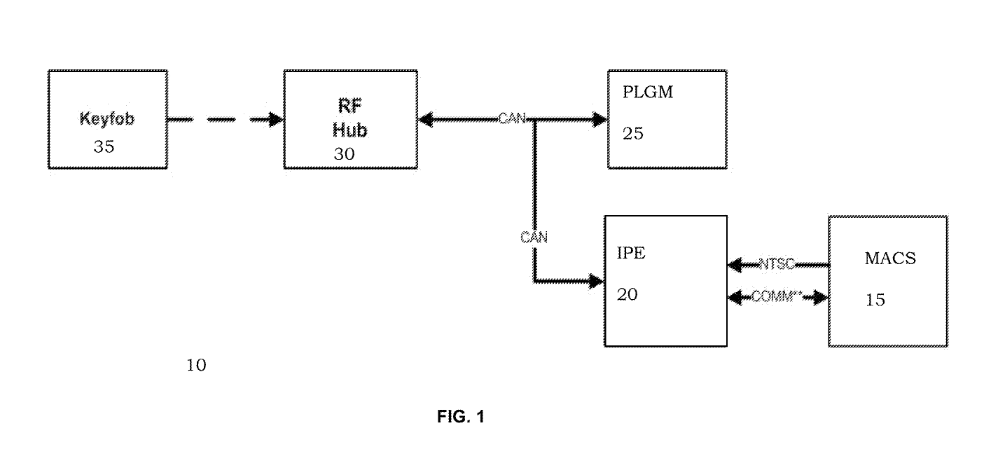

Described herein is a system and method of automated vehicle portal entry where a user does not have to retrieve a key or use a manually activated mechanism. FIG. 1 is an embodiment of an automated portal entry system 10. The automated portal entry system 10 includes a MACS module 15 in communication with an image processing engine (IPE) 20 over a communications bus (COMM), which may be a local interconnect network (LIN) bus or a hardwired input. The IPE 20 is in communication with a power lift gate module (PLGM) 25 and a radio frequency (RF) hub 30 over a controller area network (CAN) bus.

Operationally, the RF hub 30 will detect and identify a key fob 35 or some other like device and send an enable or wake-up signal to the IPE 20, which in turn will send the enable or wake-up signal to the MACS module 15. The MACS module 15 will send image or video information to the IPE 20. The information may be an analog or digital signal. For example, the analog signal may be a National Television System Committee (NTSC) composite video signal. The IPE 20 uses an image processing algorithm to determine if a person is standing at the back of the car. For example, the algorithm may be based on light, contour, or color gradient changes. The algorithm is robust enough to differentiate between a person standing next to the vehicle or a passerby. If the IPE 20 determines that a person is standing at the back of the vehicle, the IPE 20 sends an open signal to the PLGM 25 to open the lift gate.

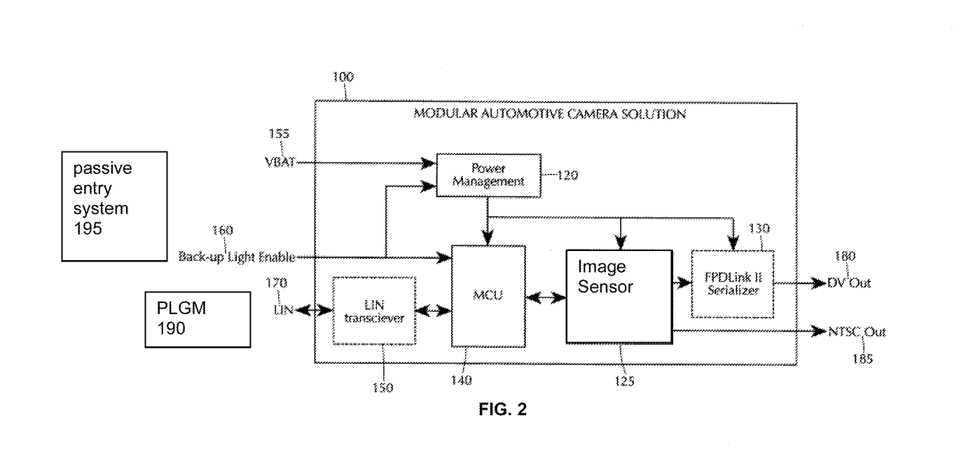

FIG. 2 is an embodiment of a MACS module 100. The MACS module 100 includes a power management module 120 that is connected to a microcontroller 140, an image sensor 125, and if available, a serializer 130. The microcontroller (MCU) 140 may be further connected to a local interconnect network (LIN) transceiver 150 and to the image sensor 125, which in turn may be connected to the serializer 130.

The MACS module 100 receives as inputs a battery voltage 155 and enable signal 160 from a passive entry system 195. The power management module 120 converts the battery voltage 155 and supplies the required voltages to the MCU 140, the image sensor 125, and if available, the serializer 130. The image sensor 125 is a complementary metal-oxide-semiconductor (CMOS) sensor based camera. The enable signal 160 is sent to the power management module 120 and the MCU 140 when identification is authenticated or verified, (for example, a key fob is detected). The MACS module 100 can be configured to output an analog National Television System Committee (NTSC) composite video signal 185 from the image sensor 125 and/or a digital video 180 through a low voltage differential signaling (LVDS) output in the serializer 130. The LIN transceiver 150 is configured to communicate via a LIN bus 170 with other vehicle electronic components or modules in the vehicle such as, for example, a passive entry system/module and a power lift gate module (PLGM) 190.

In general, the MACS module 100 is configured to recognize the presence of a user and to control the opening of, for example, a lift gate. The MACS module 100 is installed as a rear view camera module in the vehicle and works in conjunction with a passive entry system and PLGM. The MACS module 100 functions as a continuous sensor as part of a lift gate motor control mechanism. The MACS module can also be used in a minimal configuration as an automotive rear view camera or can be used in conjunction with a master module for image processing in driver assist applications like bird eye view, blind spot detection, and the like.

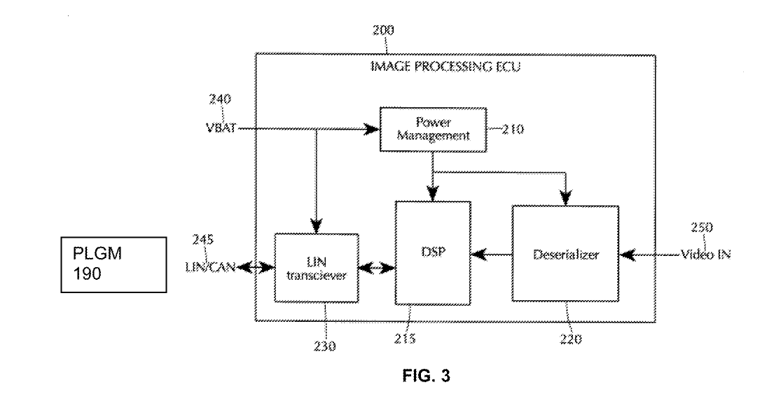

FIG. 3 is an embodiment of an image processing engine (IPE) module 200 that includes a power management module 210 connected to a digital signal processor (DSP) 215 and if applicable or available, a deserializer 220. The DSP 215 may be further connected to a local interconnect network (LIN) transceiver 230 and to the deserializer 220. The LIN transceiver 230 is configured to communicate via a LIN/controller area network (CAN) bus 245 with other vehicle electronic components or modules in the vehicle such as, for example, a passive entry system/module and a PLGM 190.

The IPE 200 receives as input a battery voltage 240 and a video information signal 250. The power management module 210 converts the battery voltage 240 and supplies the required voltages to the DSP 215 and if available, the deserializer 220. The video signal 250 is received by the deserializer 220, which in turn sends the video information signal 250 to the DSP 215 for analysis.

The IPE 200 performs image processing and communicates with both the PLGM 190 and the MACS module 100. The IPE 200 receives the video information signal 250 and based on an image processing algorithm in the DSP 215 decides if a person is standing at the back of the car. The algorithm can be based on light, contour or color gradient changes. The algorithm differentiates between a person standing and a passerby. In case of a positive determination, the IPE 200 communicates to the PLGM 190 via the LIN transceiver 230 over the LIN/CAN bus 245 to open the lift gate.

Operationally, a person will need to carry the proper identification, i.e. a key fob or other similar identification and be in the field of view of the rearview camera of the MACS module 100. The passive entry system 195 detects and/or authenticates the key fob, and sends an enable signal 160 to the PLGM 190, IPE 200 and the MACS module 100. The IPE 200 reads the image captured by the rearview camera/image sensor 125 of the MACS module 100 and determines if the lift gate should be opened. In an embodiment, the person may need to gesture in a predetermined manner, for example, waving a knee in front of the rearview camera, (which may be located above the license plate, inside the license plate lights bar), to ensure or increase the reliability or robustness of the detection algorithm. The decision is communicated to the PLGM 190 that controls the lift gate.

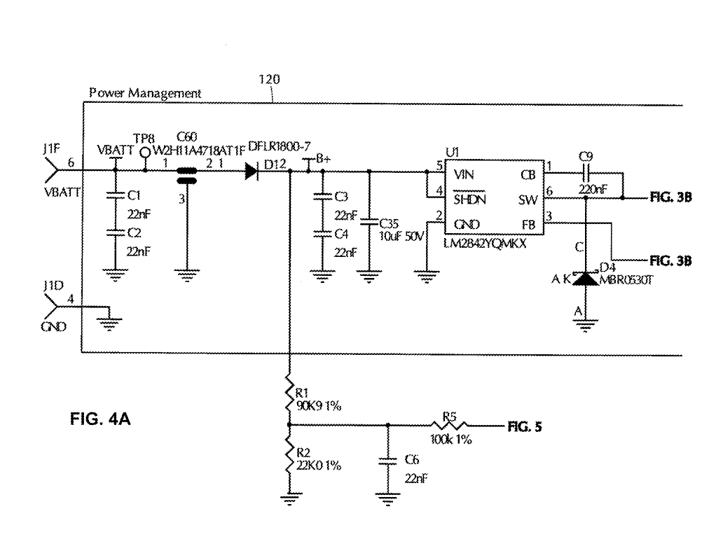

FIGS. 4A-9 show an embodiment of the MACS module 100. The power management module 120 may include an example switch mode power supply circuit 300 and an example linear low dropout regulator circuit 305, embodiments for which are shown in FIGS. 4A and 4B. The switch mode power supply circuit 300 is configured to convert the battery voltage into the 3.3V required to supply the microcontroller 140, the serializer 130, and the analog and internal circuitries of the image sensor 125. The linear low dropout regulator 305 is configured to convert the 3.3V to the 1.5V required to supply the digital core of the image sensor 125.

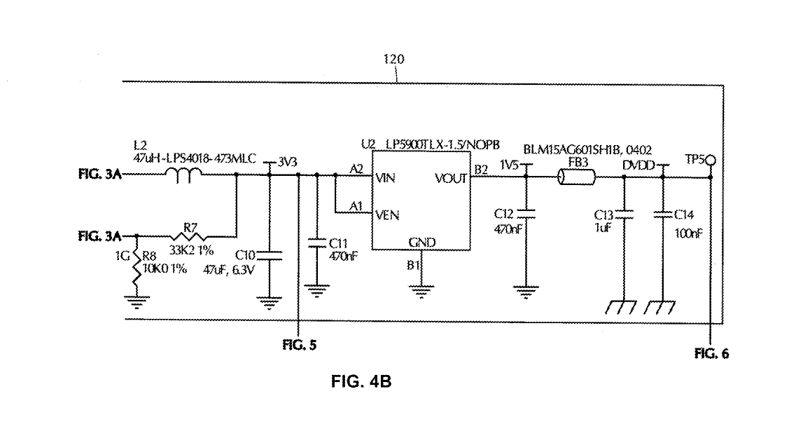

FIG. 5 shows an embodiment of an enable circuit 410 and a LIN circuit 420. The enable circuit 410 is a digital input interface which allows the camera module to be awakened on an external hard wired input. In the case of the rear view camera application, this input can be the backup lights signal. The LIN circuit 420 includes a LIN transceiver integrated circuit (IC) 425 which interfaces the LIN bus 170 with the MCU 140. The LIN circuit 420 may also be used to wake up the MACS module 100 on a bus request and may be used for MCU 140 re-flashing. It may also be used for remote and/or real time update of the registers in the image sensor 125. For example, on a birds view application when four cameras are used, the image sensor parameters of each camera need to be controlled as a function of specific light conditions. This is also applicable for lift gate control applications if the IPE 200 needs to control and/or adjust the MACS module 100/camera parameters.

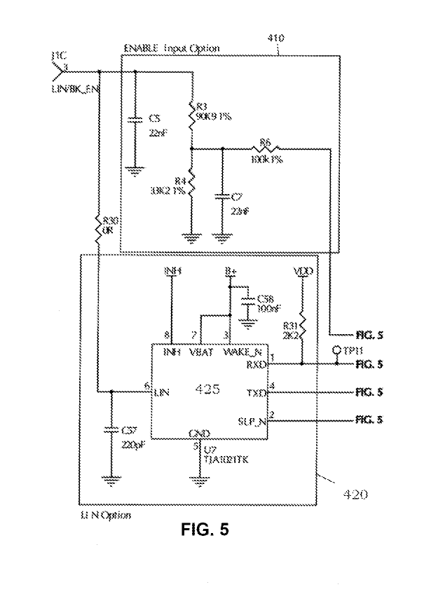

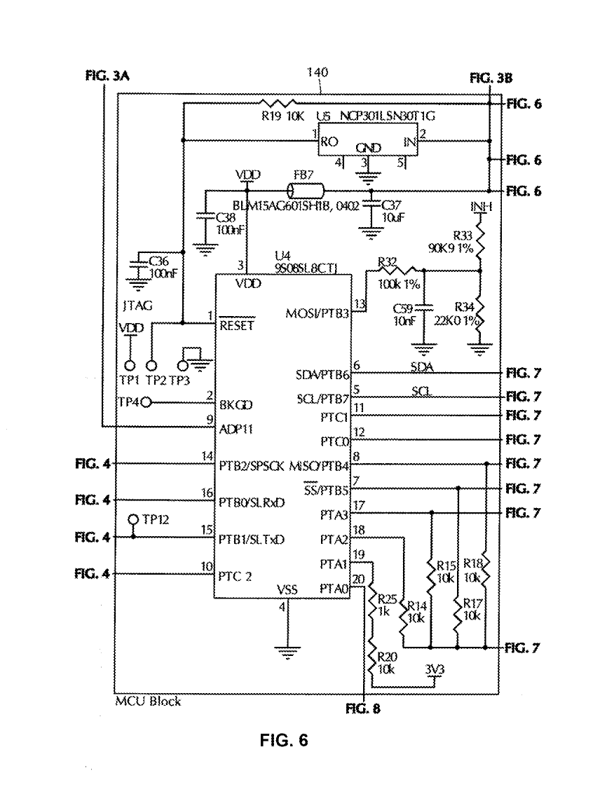

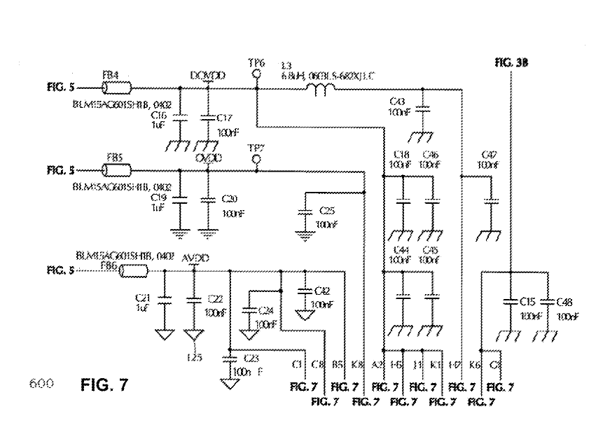

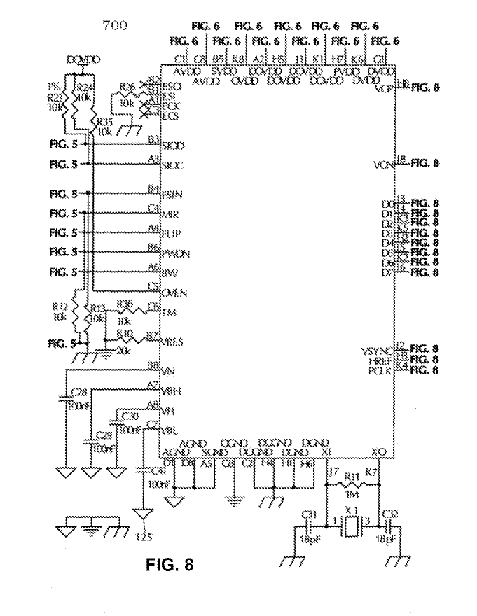

FIG. 6 shows an embodiment of a microcontroller circuit 140 and FIG. 7 shows an embodiment of circuits 600 interconnecting the microcontroller circuit 140 of FIG. 6 and an image sensor 700 of FIG. 8. The microcontroller circuit 140 updates the registers on an image sensor 700 through the I²C bus after a power on reset. It monitors the vehicle battery voltage through the R1, R2 resistive voltage divider network shown in FIG. 4A. It also controls the power up/down of the image sensor 700 via the circuits 600 and a serializer IC 805 of a serializer circuit 130 as shown in FIG. 9, (i.e. output pins 8 and 20). The microcontroller circuit 140 communicates with the other modules in the vehicle via the LIN circuit 420 shown in FIG. 5.

FIG. 8 shows an embodiment of the image sensor 700, which may be for example, an Omnivision® OV07955, an automotive video graphics array (VGA) sensor. The image sensor 700 outputs both an analog video signal, (i.e. NTSC or PAL) and an 8 bit digital video signal. For example, the analog video signal is NTSC signal 185 in FIG. 9.

FIG. 9 shows an embodiment of the serializer circuit 130 that includes the serializer IC 805. The serializer IC 805 processes a parallel digital video output together with a vertical synchronization signal (VSYNC), a horizontal synchronization signal (HSYNC) and pixel clock information and outputs a two wire differential serial signal. This signal is sent to the IPE 200 and used to detect the presence of the driver at the back of the vehicle.

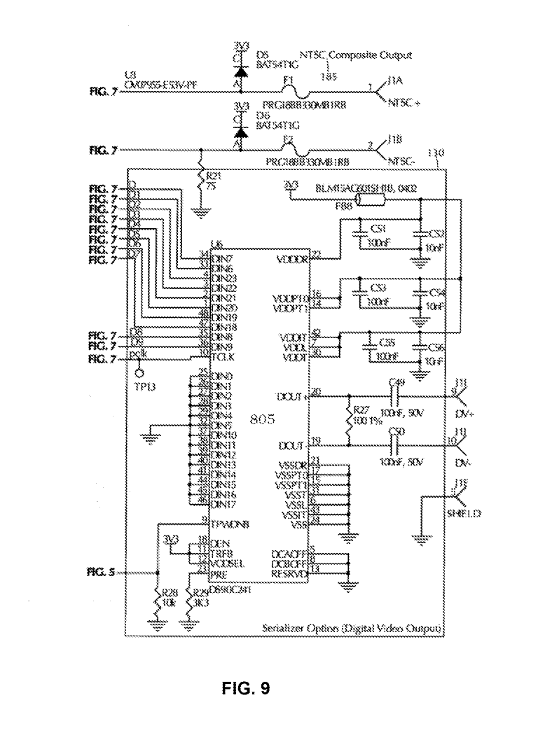

FIG. 10 is an embodiment of an automated portal entry system 1000 with a MACS module integrated with an IPE module. The automated portal entry system 1000 is in part located at a lift gate 1005 and includes a drive system 1015, a MACS module 1020 and PLGM 1010 which are interconnected as described herein above. The MACS module 1020 includes an IPE submodule 1030 and a MACS submodule 1025. The automated portal entry system 1000 functions or operates as described herein above for any of the embodiments.

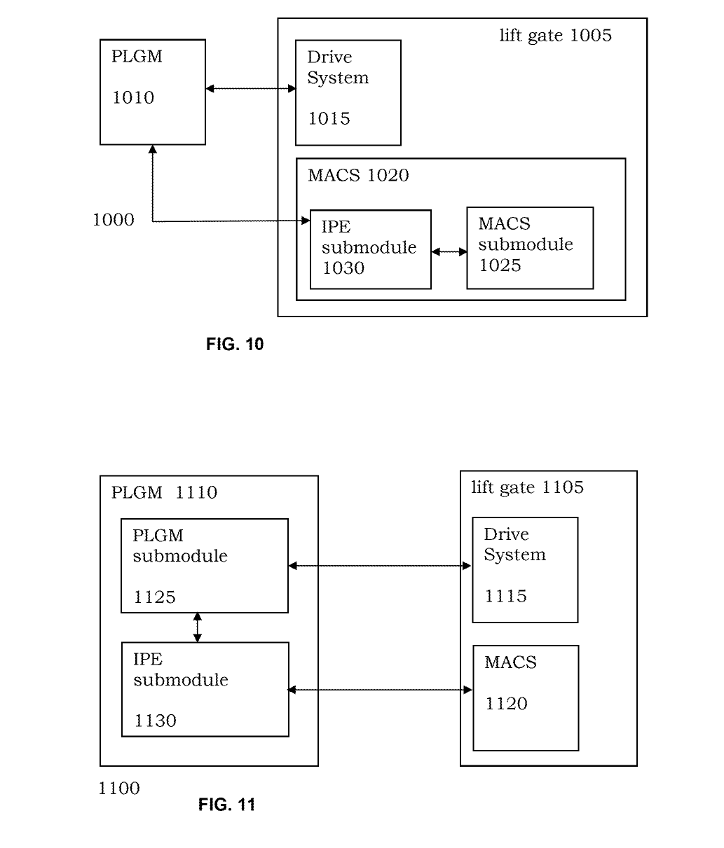

FIG. 11 is an embodiment of an automated portal entry system 1100 with a power lift gate module (PLGM) integrated with an IPE module. The automated portal entry system 1100 is in part located at a lift gate 1105 and includes a PLGM 1110, a drive system 1115, and a MACS module 1120, which are interconnected as described herein above. The PLGM module 1110 includes a a PLGM submodule 1125 and an IPE submodule 1130. The automated portal entry system 1100 functions or operates as described herein above for any of the embodiments. In another embodiment, the IPE may be part of a rear zone module electronics package.

In general, embodiments for a system for automated vehicle portal entry are described herein. The system includes a camera or imaging system collocated with the portal and a mechanical or electromechanical system configured to open the portal. An image processing engive/module is configured to determine when to open the portal. This determination includes a user detection determination, a user gesture determination and a key fob determination. The user detection determination and the user gesture determination are based on images received from the camera and the key fob determination is based on radio frequency detection or the like. The key fob is associated with the user, the vehicle or both.

As described herein, the methods described herein are not limited to any particular element(s) that perform(s) any particular function(s) and some steps of the methods presented need not necessarily occur in the order shown. For example, in some cases two or more method steps may occur in a different order or simultaneously. In addition, some steps of the described methods may be optional (even if not explicitly stated to be optional) and, therefore, may be omitted. These and other variations of the methods disclosed herein will be readily apparent, especially in view of the description of the modular automotive camera solution (MACS) described herein, and are considered to be within the full scope of the invention.

Although features and elements are described above in particular combinations, each feature or element can be used alone without the other features and elements or in various combinations with or without other features and elements.

What is claimed is:

1. A system for automated vehicle portal entry, comprising:
a camera collocated with the portal;
a mechanical system configured to open the portal;
an image processing engine configured to determine when to open the portal, wherein user detection determination at the portal is based on images received from the camera; and
the image processing engine configured to activate the mechanical system to open the portal based on the user detection determination.

2. The system of claim 1, wherein the image processing engine includes a power management unit, local interconnect network/control area network transceivers, a digital signal processor, and a deserializer.

3. The system of claim 1, wherein the user detection determination further includes a user gesture determination based on the images received from the camera.

4. The system of claim 1, wherein the image processing engine is configured to verify key fob detection associated with a user.

5. The system of claim 1, wherein the image processing engine is integrated with one of the camera or a power lift gate module.

6. A method for automatically activating a portal of a vehicle, the method comprising:
receiving an image from a camera collocated with the portal; and
processing the image to determine whether to open the portal based on the image.

7. The method of claim 6, wherein the processing includes determining whether a user is at the portal.

8. The method of claim 7, wherein the processing includes determining whether a user has made a gesture.

9. The method of claim 8, further comprising:
determining whether a keyfob is within a certain range of the vehicle.

10. A vehicle, comprising:
a camera system collocated with a portal on the vehicle;
an electromechanical system configured to open the portal;
an image processing system configured to open the portal when a user is detected based on images received from the camera system; and
the image processing system configured to activate the electromechanical system to open the portal if the user is detected.

11. The vehicle of claim 10, wherein the image processing system includes a power management unit, local interconnect network/control area network transceivers, a digital signal processor, and a deserializer.

12. The vehicle of claim 10, wherein the image processing system is configured to open the portal when a gesture from the user is also detected based on the images received from the camera system.

13. The vehicle of claim 12, wherein the image processing system is configured to open the portal when a key fob associated with the vehicle is also authenticated.

14. The vehicle of claim 10, wherein the image processing system is integrated with the camera system.

15. A system for automated vehicle portal entry, comprising:
an imaging system collocated with the portal;
an electromechanical system configured to open the portal;
a processing module configured to analyze images from the imaging system to determine the presence of a user; and
the processing module configured to signal the electromechanical system to open the portal based on the presence of the user.

16. The system of claim 15, wherein the processing module includes a power management unit, local interconnect network/control area network transceivers, a digital signal processor, and a deserializer.

17. The system of claim 15, wherein the processing module is configured to determine if the user has made a gesture based on images from the imaging system.

18. The system of claim 17, wherein the image processing module is configured to verify key fob detection associated with the user and the vehicle.

19. The system of claim 15, wherein the processing module is integrated with the imaging system.
